(19) United States
(12) Patent Application Publication
(10) Pub. No.: US 2018/0082797 A1
(43) Pub. Date: Mar. 22, 2018

(54) ELECTRODE MATERIAL FOR ELECTRONIC DEVICE AND ELECTRONIC DEVICE COMPRISING THE SAME

(71) Applicant: LG INNOTEK CO., LTD., Seoul (KR)

(72) Inventors: Seung Kwon HONG, Seoul (KR); Hyuk Soo LEE, Seoul (KR); In Hee CHO, Seoul (KR); Hyun Gyu PARK, Seoul (KR)

(21) Appl. No.: 15/560,964

(22) PCT Filed: Mar. 24, 2016
(86) PCT No.: PCT/KR2016/002978

§ 371 Date: Sep. 22, 2017

(30) Foreign Application Priority Data
Mar. 24, 2015 (KR) 10-2015-0040827

(51) Int. Cl. H01G 11/42; H01G 11/24; H01G 11/86

(52) U.S. Cl. CPC H01G 11/42; H01G 11/86; H01G 11/24

(57) ABSTRACT

An electrode material according to one exemplary embodiment of the present invention includes a silicon carbide powder including mesopores having a diameter of 2 to 50 nm and micropores having a diameter of 2 nm or less.

### TECHNICAL FIELD

The present invention relates to an electronic device capacitor, and more particularly, to an electrode material which is included in the electronic device.

### BACKGROUND ART

Supercapacitors are ultracapacitors, which are quickly chargeable or dischargeable, have a long lifespan and a high efficiency, compared to typical capacitors. The supercapacitors may be divided into electric double layer capacitors (EDLCs) using an electric double layer in which charges are disposed at the interface between an electrode and an electrolyte solution, pseudocapacitors using pseudocapacitance caused by a reversible Faraday oxidation/reduction reaction at the interface between an electrode and an electrolyte solution, and hybrid capacitors using different asymmetric electrodes as positive and negative electrodes.

In this case, activated carbon has been generally used as an electrode material for electric double layer capacitors, but has a limitation of being implemented with high capacity due to its low conductivity and relative permittivity. To overcome the limitations of the activated carbon, the use of carbon nanotubes, graphene, carbon aerogel, metal carbide-derived carbon and the like has been attempted, but has limitations in forming cells due to high costs and low density.

### DISCLOSURE

### Technical Problem

Therefore, the present invention is directed to providing an electrode material having high relative permittivity and an electronic device including the same.

### Technical Solution

To solve the above problem, one aspect of the present invention provides an electrode material for an electronic device which includes a silicon carbide powder including mesopores having a diameter of 2 to 50 nm and micropores having a diameter of 2 nm or less.

The silicon carbide powder may have a specific surface area of 1,500 to 2,500 m²/g and a conductivity of 60 siemens/cm or more.

An area of the mesopores may account for 45 to 65% of the sum of areas of the mesopores and the micropores.

The silicon carbide powder may be in a β phase.

An X-ray diffraction (XRD) pattern of the silicon carbide powder may exhibit a (1 1 1) plane at 2θ=35.6°±1°.

Another aspect of the present invention provides an electronic device including an electrode including a silicon carbide powder. Here, the silicon carbide powder includes mesopores having a diameter of 2 to 50 nm and micropores having a diameter of 2 nm or more.

The capacitor may include a first electrode including the silicon carbide powder, a second electrode including the silicon carbide powder, and a separator disposed between the first electrode and the second electrode.

At least one of the first electrode and the second electrode may have a thickness of 50 to 200 μm.

The electronic device may have a relative permittivity of 100 to 300 F/g.

### Advantageous Effects

According to exemplary embodiments of the present invention, an electrode material for an electronic device, which has high relative permittivity, and an electronic device including the same may be obtained. In particular, it is possible to obtain an electrode material which is inexpensive and simultaneously has high relative permittivity due to high conductivity and specific surface area, thereby exhibiting excellent performance.

### DESCRIPTION OF DRAWINGS

FIG. 1 is a cross-sectional view of an electric double layer capacitor.

FIG. 2 shows a coin-type electric double layer capacitor.

FIG. 3 shows a pouch-type electric double layer capacitor.

FIG. 4 shows a cylinder-type electric double layer capacitor.

FIG. 5 is a scanning electron microscope (SEM) image of a silicon carbide powder according to one exemplary embodiment of the present invention.

FIG. 6 is a transmission electron microscope (TEM) image of the silicon carbide powder according to one exemplary embodiment of the present invention.

FIG. 7 is a diagram for describing pores in the silicon carbide powder according to one exemplary embodiment of the present invention.

FIG. 8 is an enlarged diagram showing the pores in the silicon carbide powder according to one exemplary embodiment of the present invention.

FIG. 9 shows pores formed in activated carbon.

FIG. 10 shows pores formed in a typical porous silicon carbide powder.

FIG. 11 is a diagram illustrating a method of preparing a silicon carbide powder according to one exemplary embodiment of the present invention.

FIG. 12 is a diagram showing an XRD pattern of the silicon carbide powder prepared by the preparation method shown in FIG. 11.

FIG. 13 is a cross-sectional view of an electric double layer capacitor using the silicon carbide powder according to one exemplary embodiment of the present invention.

### MODE FOR INVENTION

The present invention may be modified in various forms and have various embodiments, and thus particular embodiments thereof will be illustrated in the accompanying drawings and described in the detailed description. However, it should be understood that the description set forth herein is not intended to limit the present invention, and encompasses all modifications, equivalents, and substitutions that do not depart from the spirit and scope of the present invention.

Although the terms encompassing ordinal numbers such as “first,” “second,” etc. may be used to describe various elements, these elements are not limited by these terms. These terms are only used for the purpose of distinguishing one element from another. For example, a first element could be termed a second element, and, similarly, a second element could be termed a first element without departing from the scope of the present invention. The term “and/or” includes any and all combinations of a plurality of associated listed items.

The terminology provided herein is merely used for the purpose of describing particular embodiments, and is not intended to be limiting of exemplary embodiments of the present invention. The singular forms “a,” “an” and “the” are intended to include the plural forms as well, unless the context clearly indicates otherwise. It should be understood that the terms “comprises,” “comprising,” “includes” and/or “including,” when used herein, specify the presence of stated features, integers, steps, operations, elements, components and/or combinations thereof, but do not preclude the presence or addition of one or more other features, integers, steps, operations, elements, components and/or combinations thereof.

Unless defined otherwise, all the terms (including technical and scientific terms) used herein have the same meaning as commonly understood by one of ordinary skill in the art to which the present invention belongs. It will be further understood that the terms, such as those defined in commonly used dictionaries, should be interpreted as having meanings that are consistent with their meanings in the context of the relevant art, and will not be interpreted in an idealized or overly formal sense unless expressly defined otherwise herein.

It will be understood that when it is assumed that a part such as a layer, film, region, or substrate is disposed “on” another part, it can be directly disposed on the other part or intervening parts may also be present therebetween. On the other hand, it will be understood that when it is assumed that a part such as a layer, film, region, or substrate is “directly disposed on” another part, no intervening parts may be present therebetween.

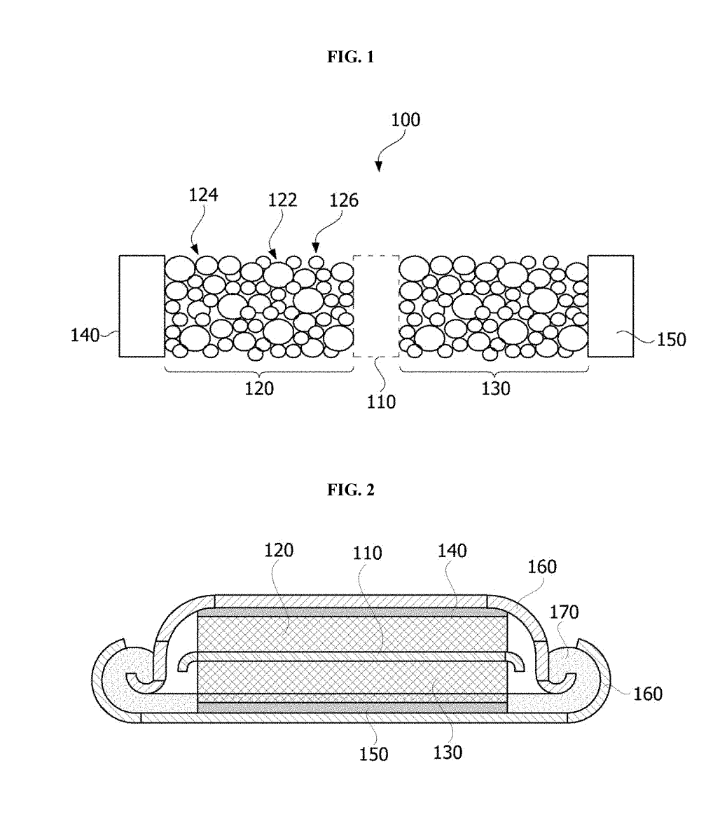

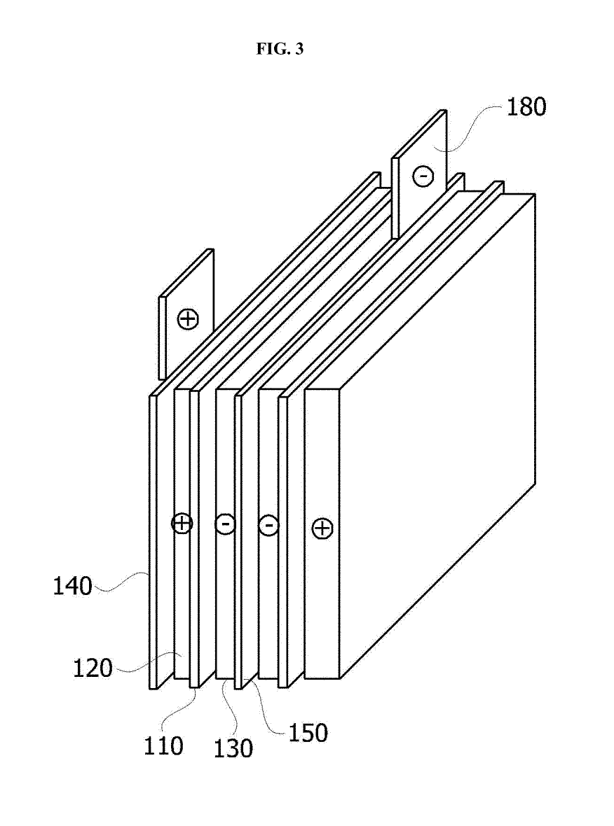

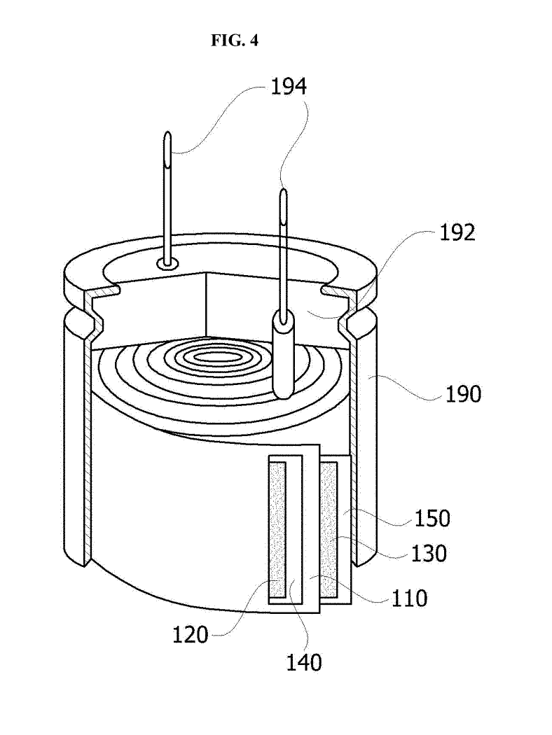

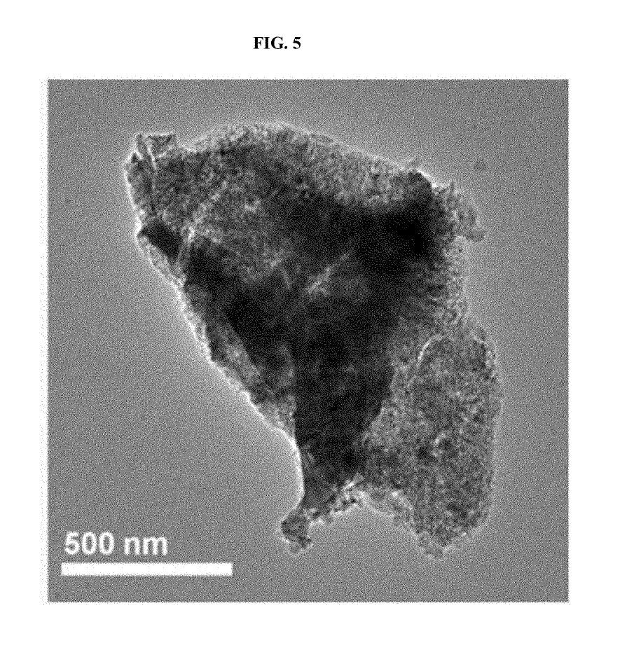

FIG. 1 is a cross-sectional view of an electric double layer capacitor, FIG. 2 shows a coin-type electric double layer capacitor, FIG. 3 shows a pouch-type electric double layer capacitor, and FIG. 4 shows a cylinder-type electric double layer capacitor.

Referring to FIGS. 1 to 4, electric double layer capacitor (EDLC) 100 includes a separator 110 and a pair of electrodes 120 and 130 separated by the separator 110. The electrodes 120 and 130 are coupled to collectors 140 and 150, and are filled with active materials 122 and 132, binders 124 and 134, and conductive materials 126 and 136, respectively.

Here, the separator 110 may be an insulating film including at least one selected from the group consisting of a polyolefin, polyethylene terephthalate, a polyamide, a polyimide, cellulose, and glass fibers. The separator 110 may be a porous film.

The active materials 122 and 132 included respectively in the electrodes 120 and 130 may be porous materials having high conductivity. When the active materials 122 and 132 have high conductivity and a large specific surface area, relative permittivity may be enhanced, resulting in an increase of the electricity storage capacity in cells. Also, the active materials 122 and 132 included respectively in the electrodes 120 and 130 may be porous materials having a high density. When the active materials 122 and 132 have a high density and a large specific surface area, the volume of the cells may be reduced, and high capacity may also be realized.

The binders 124 and 134 included respectively in the electrodes 120 and 130 may be selected from polymer-based resins, for example, polyvinylidene chloride, polytetrafluoroethylene, polyvinyl pyrrolidone, polyvinyl chloride, a polyolefin, styrene butadiene rubber, polyvinyl alcohol, and carboxymethyl cellulose. The binders 124 and 134 may be included at a content of 0.2 to 10 parts by weight, based on 100 parts by weight of the active materials 122 and 132. When the contents of the binder 124 and the active material 122 satisfy this numerical range, an increase in electric resistance and a decrease in discharge capacity may be prevented, and a binding strength between the binders 124 and 134 and the active materials 122 and 132 may also be improved.

The conductive materials 126 and 136 included respectively in the electrodes 120 and 130 may, for example, be selected from carbon black, acetylene black, Ketjen black, carbon fibers, graphite, and ruthenium oxide. Each of the conductive materials 126 and 136 may be included at a content of 10 parts by weight or less, based on 100 parts by weight of the active material. When the contents of the conductive materials 126 and 136 are out of this numerical range, the electrostatic capacity of cells may somewhat be degraded. Also, when the active materials 122 and 132 having high conductivity are used, the conductive materials 126 and 136 may not be added.

The collectors 140 and 150 may be made of a metal material such as aluminum, stainless steel, etc.

Also, an electrolyte may be a non-aqueous electrolyte or an aqueous electrolyte. The non-aqueous electrolyte may, for example, include a polypropylene carbonate solution obtained by dissolving tetraalkylphosphonium tetrafluoroborate, a polypropylene carbonate solution obtained by dissolving tetraalkylammonium tetrafluoroborate, a sulfolane solution, a polypropylene carbonate solution obtained by dissolving triethylammonium and tetrafluoroborate, etc. The aqueous electrolyte may be, for example, an aqueous alkaline solution such as an aqueous potassium hydroxide solution, an aqueous sodium hydroxide solution, etc.

The electrolyte is present in a form in which positive and negative ions are mixed and dissolved in a polar solvent. When a voltage is applied during charging, dissociated electrolyte ions are adsorbed onto a surface of an electrode to accumulate electricity. During discharging, the electrolyte ions break away from the electrode, and then return to a neutralized state.

Such electric double layer capacitors may be applied to various fields such as automobiles, wind power generation, copy machines, energy harvesting systems, construction equipment, etc., and may be divided into a coin-type electric double layer capacitor, a pouch-type electric double layer capacitor, and a cylinder-type electric double layer capacitor, depending on the external size and applied field.

Referring to FIG. 2, the coin-type electric double layer capacitor is configured so that a separator 110 is disposed between a pair of sheet-shaped electrodes 120 and 130, and the sheet-shaped electrodes 120 and 130 are encapsulated by upper and lower metal cases 160, and an insulation packing 170 in a state in which an electrolyte solution infiltrates into the electrodes.

Referring to FIG. 3, the pouch-type electric double layer capacitor is configured so that a pair of electrodes 120 and 130 at which surfaces of aluminum collector electrodes 140 and 150 are coated with an active material are disposed to face each other with an separator 110 disposed therebetween, and terminals 180 drawn out from the capacitor. The pouch-type electric double layer capacitor may be easily manufactured with low diffusion resistance, high capacity and large power output since the electrodes have a large facing area and a small thickness.

Referring to FIG. 4, the cylinder-type electric double layer capacitor is configured so that a pair of electrodes 120 and 130 at which surfaces of aluminum collector electrodes 140 and 150 are coated with an active material are wound with a separator 110 disposed therebetween, and an electrolyte solution infiltrates into the collector electrodes 140 and 150 to insert the electrodes into an aluminum case 190, and a structure 192 is sealed with a rubber. Lead wires 194 are connected to the aluminum collector electrodes 140 and 150, and terminals are drawn out from the lead wires 194.

According to one exemplary embodiment of the present invention, a carbide powder is intended to be used as the active material of the electric double layer capacitor.

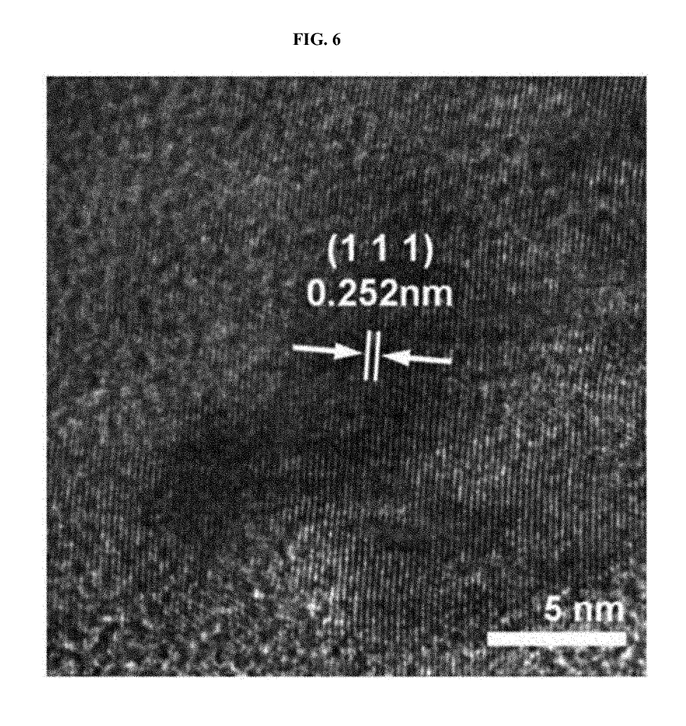

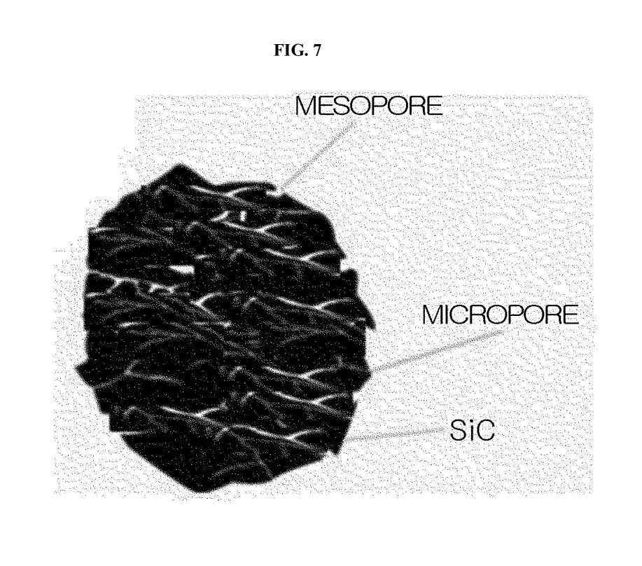

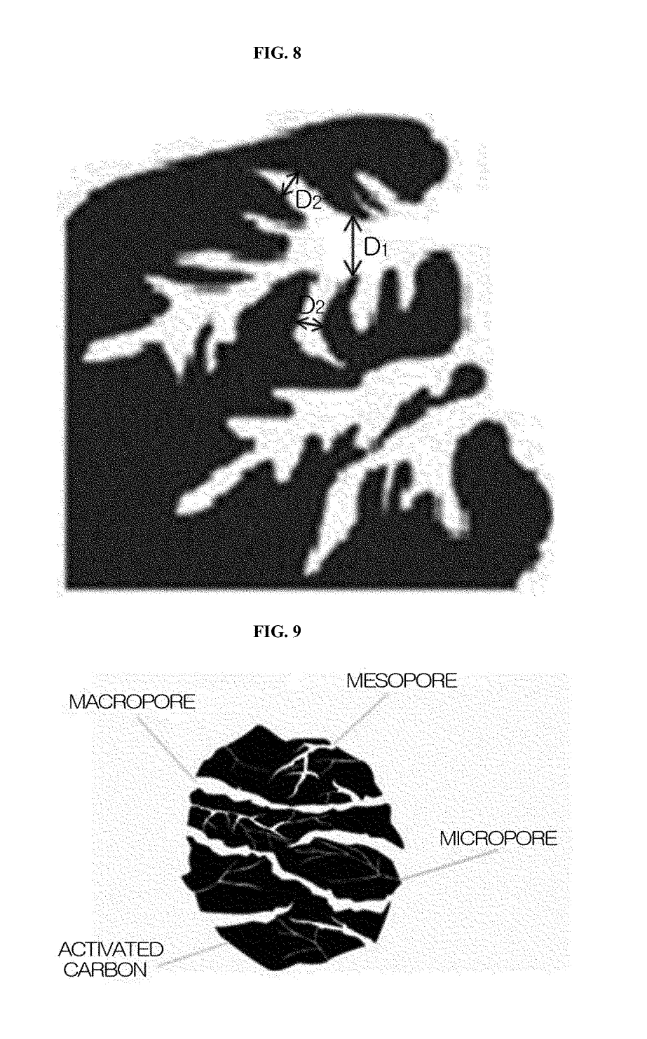

FIG. 5 is a scanning electron microscope (SEM) image of a silicon carbide powder according to one exemplary embodiment of the present invention, FIG. 6 is a transmission electron microscope (TEM) image of the silicon carbide powder according to one exemplary embodiment of the present invention, FIG. 7 is a diagram for describing pores in the silicon carbide powder according to one exemplary embodiment of the present invention, and FIG. 8 is an enlarged diagram showing the pores in the silicon carbide powder according to one exemplary embodiment of the present invention.

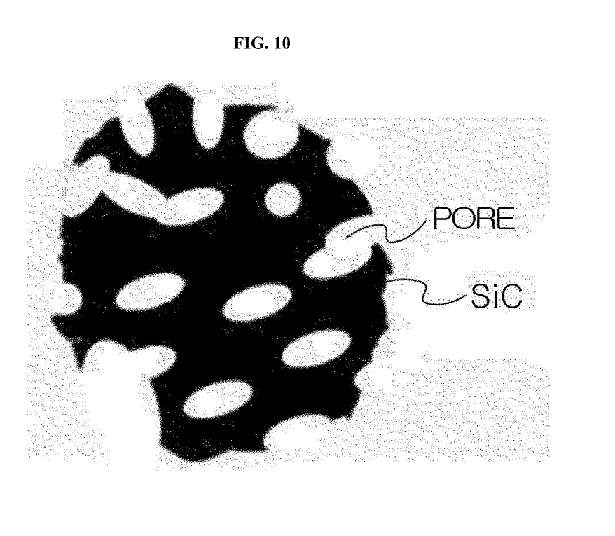

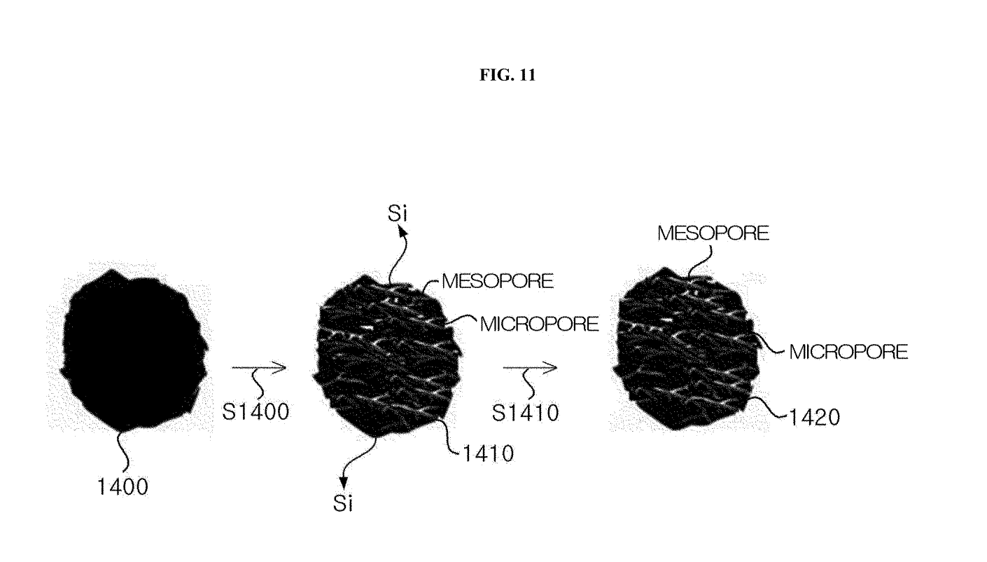

For comparison with the silicon carbide powder according to one exemplary embodiment of the present invention, FIG. 9 shows pores formed in activated carbon, and FIG. 10 shows pores formed in a typical porous silicon carbide powder.

Referring to FIGS. 5 to 8, the silicon carbide powder according to one exemplary embodiment of the present invention is porous. In this case, the silicon carbide powder may include a β phase, and an XRD pattern of the silicon carbide powder may exhibit a (1 1 1) plane at 2θ=35.6°±1°.

As shown in FIG. 8, the silicon carbide powder according to one exemplary embodiment of the present invention may include mesopores having a diameter D1 of 2 to 50 nm and micropores having a diameter D2 of 2 nm or less, and the plurality of micropores may branch from the mesopores. Also, an area of the mesopores formed in the silicon carbide powder may account for 45 to 65% of the sum of areas of the mesopores and micropores. When the area of the mesopores is less than 45% of the sum of the areas of the mesopores and micropores or greater than 65% of the sum of the areas of the mesopores and micropores, the specific surface area of the silicon carbide powder may be reduced to less than 1,500 m²/g. Therefore, the surface area of the silicon carbide powder used to adsorb charges may be reduced, and relative permittivity may be lowered to less than 100 F/g, and electricity storage capacity may be reduced during cell formation.

Accordingly, the specific surface area of the silicon carbide powder according to one exemplary embodiment of the present invention may be in a range of 1,500 to 2,500 m²/g, and the conductivity of the silicon carbide powder may be greater than or equal to 60 siemens/cm. As a result, when a cell is formed using the silicon carbide powder according to one exemplary embodiment of the present invention, a relative permittivity ranging from 100 to 300 F/g may be obtained.

On the other hand, the activated carbon shown in FIG. 9 has a specific surface area similar to the silicon carbide powder according to one exemplary embodiment of the present invention, but has a conductivity of 1 to 10 siemens/cm. Therefore, a relative permittivity ranging from 80 to 120 F/g may be obtained. As a result, when the silicon carbide powder according to one exemplary embodiment of the present invention is used as an electrode material for electric double layer capacitors, superior performance may be achieved, compared to the activated carbon.

Meanwhile, the graphene or carbon nanotubes have a higher relative permittivity than the activated carbon, but have limitations in actually forming a cell due to high manufacturing costs.

Also, the silicon carbide powder according to one exemplary embodiment of the present invention has a density of 3 to 3.2 g/cm³. However, macropores having a diameter of 50 nm or more as well as the mesopores and the micropores may also be formed in the activated carbon. Accordingly, the activated carbon is shown to have a low density of 0.5 to 0.7 g/cm³. As a result, it can be seen that, when the silicon carbide powder according to one exemplary embodiment of the present invention is used as the electrode material, the volume of cells may be significantly reduced, compared to when the activated carbon is used.

Meanwhile, in the case of a typical porous silicon carbide powder prepared using a method of mixing a silicon carbide powder and a metal powder, sintering the resulting mixture and removing the metal powder by etching, pores are formed in sites from which the metal powder is removed, as shown in FIG. 10. Such pores have a size larger than the micropores. As a result, since the specific surface area of the porous silicon carbide powder obtained as shown in FIG. 10 is significantly smaller than that of the silicon carbide powder according to one exemplary embodiment of the present invention, the relative permittivity may also be shown to be low.

The silicon carbide powder according to one exemplary embodiment of the present invention may be manufactured as shown in FIG. 11.

Referring to FIG. 11, a silicon powder 1400 is prepared. Here, the silicon powder 1400 may have a diameter of 500 nm to 100 μm. For example, the silicon powder 1400 may be obtained by grinding silicon wafer waste generated in a wafer production process for manufacturing a semiconductor, or a semiconductor manufacturing process. A wafer used to obtain the silicon powder 1400 may have a main peak at 2θ=28.4°±0.1° in an XRD pattern.

Then, the prepared silicon powder 1400 is vaporized (S1400). For this purpose, a reactor in which the silicon powder 1400 is accommodated is filled with an inert gas such as argon or nitrogen, and then maintained at 1,200 to 1,800° C. In this case, the reactor rotates in a closed state, and only the inert gas may be injected/discharged into/from the reactor. Therefore, the silicon powder is vaporized so that some of Si atoms break away from the silicon powder, and mesopores and micropores are formed at sites from which the Si atoms broke away. At least some of the micropores may branch from the mesopores.

Subsequently, the vaporized silicon powder 1410 is carbonized (S1410). For this purpose, methane or ethane gas is injected into the reactor in a state in which the temperature of the reactor is maintained in a range of 1,200 to 1,800° C.

Therefore, a silicon carbide powder 1420 having mesopores and micropores formed therein may be obtained. When the temperature of the reactor is maintained in a range of 1,200 to 1,800° C. during the vaporization of the silicon powder in step S1400 and carbonization of the silicon powder in step S1410, it is possible to obtain a silicon carbide powder including mesopores having a diameter of 2 to 50 nm and micropores having a diameter of 2 nm or less. Here, the area of the mesopores accounts for 45 to 65% of the sum of the areas of the mesopores and the micropores. When the temperature of the reactor is maintained at less than 1,200° C., Si is not vaporized, and thus the mesopores and the micropores may not be formed. When the temperature of the reactor is maintained at greater than 1,800° C., Si is excessively vaporized, resulting in a wider area of the macropores. Therefore, the silicon carbide powder is shown to have a specific surface area of 1,500 m²/g. Also, when the temperature of the reactor is maintained at greater than 2,000° C., the silicon powder is melted, thereby no pores are formed.

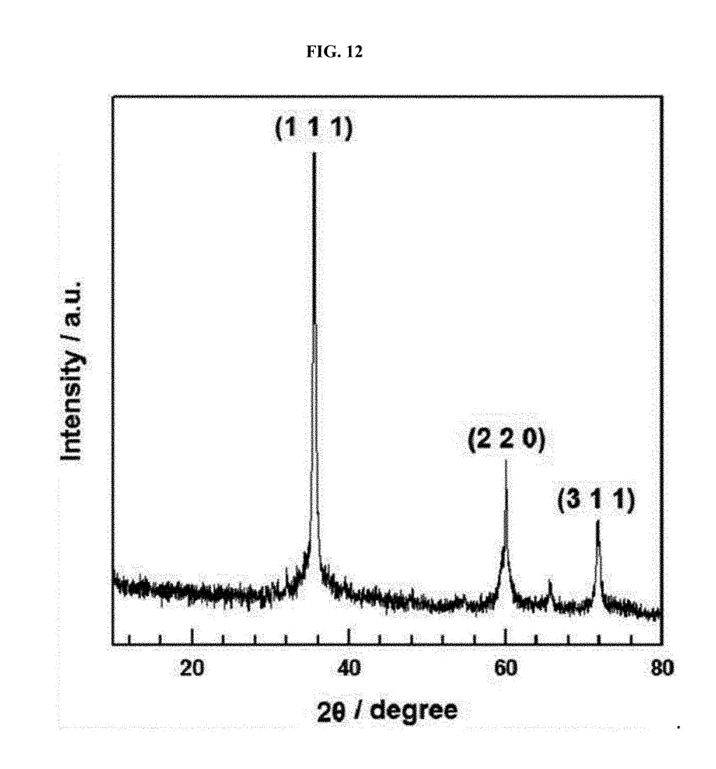

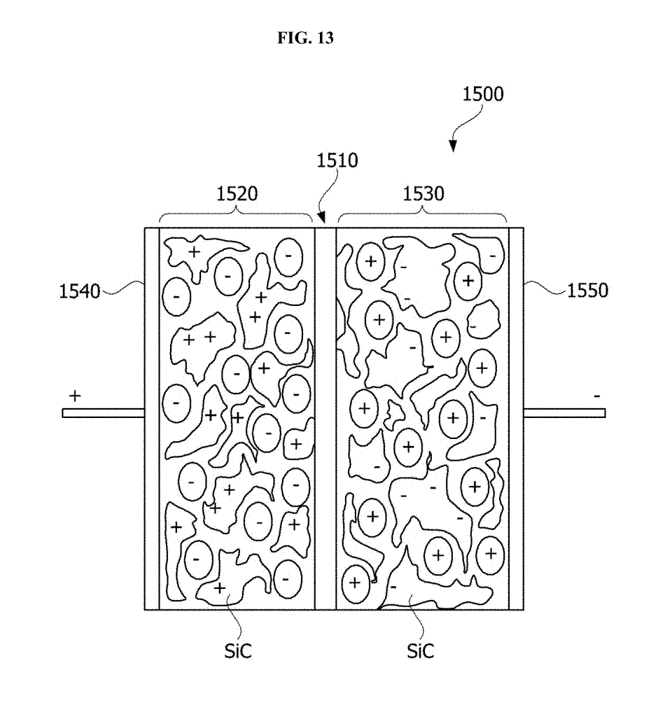

On the other hand, FIG. 12 shows a measured XRD pattern of the silicon carbide powder prepared by the preparation method shown in FIG. 11. Referring to FIG. 12, it can be seen that the silicon carbide powder according to one exemplary embodiment of the present invention is a β phase silicon carbide powder having a (1 1 1) plane at 2θ=35.6°±1°.

FIG. 13 is a cross-sectional view of an electric double layer capacitor using the silicon carbide powder according to one exemplary embodiment of the present invention.

Referring to FIG. 13, an electric double layer capacitor 1500 includes a separator 1510 and a pair of electrodes 1520 and 1530 separated by the separator 1510 and disposed in an electrolyte solution. The electrodes 1520 and 1530 are coupled to collectors 1540 and 1550, respectively, and are filled with a binder and the silicon carbide powder according to one exemplary embodiment of the present invention. In this case, the binder may be a polymer-based resin, and may be included at a content of 0.2 to 10 parts by weight, based on 100 parts by weight of the silicon carbide powder according to one exemplary embodiment of the present invention. When the binder is included in this numerical range, electric resistance may be improved or degradation of discharge capacity may be prevented due to addition of the binder, thereby improving a binding strength between the binder and the silicon carbide powder.

According to one exemplary embodiment of the present invention, since the silicon carbide powder having high conductivity is used as the electrode material, a conductive material need not be further added to the electrode.

In this case, the electrode has a thickness of 50 to 200 μm. When the thickness of the electrode is less than 50 μm or greater than 200 μm, the electricity storage capacity of a cell may be degraded due to a decrease in the electron transfer rate.

In this specification, one example in which the silicon carbide powder according to one exemplary embodiment of the present invention is applied to the capacitor has been described, but the present invention is not limited thereto. The silicon carbide powder according to one exemplary embodiment of the present invention may be used as the electrode material for various electronic devices.

In this specification, one example in which the silicon carbide powder according to one exemplary embodiment of the present invention is applied to the electric double layer capacitor has been described, but the present invention is not limited thereto. The silicon carbide powder according to one exemplary embodiment of the present invention may be used as the electrode material for various supercapacitors such as pseudocapacitors and hybrid capacitors as well as the electric double layer capacitors.

While the present invention has been shown and described with reference to certain exemplary embodiments thereof, it will be understood by those skilled in the art that various changes in form and details may be made therein without departing from the spirit and scope of the invention as defined by the appended claims.

### BRIEF DESCRIPTION OF PARTS IN DRAWINGS

1500: electric double layer capacitor
1510: separator
1520, 1530: electrode
1540, 1550: collector electrode

1. An electrode material for an electronic device comprising a silicon carbide powder comprising mesopores having a diameter of 2 to 50 nm and micropores having a diameter of 2 nm or less,
wherein some of the micropores branch from the mesopores.

2. The electrode material of claim 1, wherein the silicon carbide powder has a specific surface area of 1,500 to 2,500 m²/g and a conductivity of 60 siemens/cm or more.

3. The electrode material of claim 1, wherein an area of the mesopores accounts for 45 to 65% of the sum of areas of the mesopores and the micropores.

4. The electrode material of claim 1, wherein the silicon carbide powder is in a β phase.

5. The electrode material of claim 4, wherein an X-ray diffraction (XRD) pattern of the silicon carbide powder exhibits a (1 1 1) plane at 2θ=35.6°±1°.

6. The electrode material of claim 1, wherein the silicon carbide powder has a density of 3 to 3.2 g/cm³.

7. (canceled)

8. An electronic device comprising an electrode comprising a silicon carbide powder,
wherein the silicon carbide powder comprises mesopores having a diameter of 2 to 50 nm and micropores having a diameter of 2 nm or less,
wherein some of the micropores branch from the mesopores.

9. The electronic device of claim 8, comprising:
a first electrode comprising the silicon carbide powder;
a second electrode comprising the silicon carbide powder; and
a separator disposed between the first electrode and the second electrode.

10. The electronic device of claim 9, wherein at least one of the first electrode and the second electrode has a thickness of 50 to 200 μm.

11. The electronic device of claim 8, wherein the electrode further comprises a binder.

12. The electronic device of claim 11, wherein the binder comprises a polymer-based resin.

13. The electronic device of claim 11, wherein the binder is included at a content of 0.2 to 10 parts by weight, based on 100 parts by weight of the silicon carbide powder.

14. The electronic device of claim 8, wherein the electronic device comprises a capacitor.

15. The electronic device of claim 14, wherein the capacitor comprises at least one selected from the group consisting of an electric double layer capacitor, a pseudocapacitor, and a hybrid capacitor.

16. The electronic device of claim 8, which has a relative permittivity of 100 to 300 F/g.

17. The electronic device of claim 8, wherein the silicon carbide powder has a specific surface area of 1,500 to 2,500 m²/g and a conductivity of 60 siemens/cm or more.

18. The electronic device of claim 8, wherein an area of the mesopores accounts for 45 to 65% of the sum of areas of the mesopores and the micropores.

19. The electronic device of claim 8, wherein the silicon carbide powder is in a β phase.

20. The electronic device of claim 19, wherein an XRD pattern of the silicon carbide powder exhibits a (1 1 1) plane at 2θ=35.6°±1°.

21. (canceled)

22. A method of manufacturing an electrode material for an electronic device comprising:
preparing a silicon powder having a diameter of 500 nm to 100 μm,
vaporizing a portion of the silicon powder at 1,200 to 1,800° C., and
carbonizing the vaporized silicon powder at 1,200 to 1800° C.
